(19) United States
(12) Patent Application Publication
(10) Pub. No.: US 2010/0199106 A1
(43) Pub. Date: Aug. 5, 2010

(54) MAGNETIC DISK APPARATUS AND CIPHER KEY UPDATING METHOD

(75) Inventor: Ikuko IIDA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/696,917

(22) Filed: Jan. 29, 2010

(30) Foreign Application Priority Data
Jan. 30, 2009 (JP) 2009-019682

(51) Int. Cl. G06F 12/14; G11B 27/36; H04L 9/06

(52) U.S. Cl. 713/189; 360/31; G9B/27.052; 380/277

(57) ABSTRACT

According to one embodiment, a magnetic disk apparatus comprises a magnetic disk configured to store encrypted data, a magnetic head configured to read data from and to write data to the magnetic disk, and a recording and reproducing circuit connected to the magnetic head, wherein the recording and reproducing circuit configured to read data from an area of the magnetic disk, to decrypt read data, to re-encrypt decrypted data with changing a cipher key, and to rewrite re-encrypted data in the area of the magnetic disk.

### CROSS-REFERENCE TO RELATED APPLICATIONS

This application is based upon and claims the benefit of priority from Japanese Patent Application No. 2009-019682, filed Jan. 30, 2009, the entire contents of which are incorporated herein by reference.

### BACKGROUND

1. Field

One embodiment of the invention relates to a magnetic disk apparatus for storing encrypted data, and a method of updating a key of the encrypted data in the same.

2. Description of the Related Art

A conventional storage system such as a magnetic disk apparatus stores data in an encrypted form for saving data securely for a long time. However, an encryption algorithm is exposed to rapidly changing technology. Even an encryption system (an encryption standard for encrypting and decrypting data) inaccessible at present may be broken a few years later. One solution to this problem is to upgrade an encryption system by using advanced encryption by using a longer cipher key or an advanced encryption algorithm, or by using the both (as disclosed in paragraphs 0004, 0005, 0023 and 0025 of Jpn. Pat. Appln. Publication No. 2005-303981).

The storage system disclosed in this application includes conversion of an encryption system of the stored data from a first encryption system to a second encryption system. A physical storage comprises blocks numbered in ascending order starting from one. Encryption system conversion is made for each block. A block encrypted by the first encryption system is converted to a block encrypted by the second encryption system. Data is first encrypted by the first system. A data block is read, and decrypted by using the first system. A second encryption system is applied to the decrypted data block, and the data block encrypted by the second encryption system is rewritten at the original position in the original block from which the data is read. Blocks are continuously numbered, and conversion of data form is made in ascending order from the lowest block number.

However, the storage system of the above patent application does not specify the timing of encryption system conversion. A host device must command conversion of encryption system at any timing. Without the command, conversion is not started. Thus, conversion of encryption system is not guaranteed in the storage system disclosed in the above patent application. Further, the process of reading data, decrypting the data, encrypting the data by another system, and rewriting the data at the original position requires much effort and time. This may affect main operation of the system.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a magnetic disk apparatus according to an embodiment of the invention.

FIG. 2 is an exemplary conceptual diagram showing a format including alignment of tracks of the disk shown in FIG. 1.

FIG. 3 is an exemplary diagram showing an example of a data structure of a write count table in the embodiment.

FIG. 4 is an exemplary diagram showing an example of data structure of a key table in the embodiment.

FIG. 5 is an exemplary flowchart for explaining a general operation in an HDD in FIG. 1.

FIG. 6 is an exemplary flowchart showing detailed blocks of a data refresh operation included in the flowchart of FIG. 5.

### DETAILED DESCRIPTION

Various embodiments according to the invention will be described hereinafter with reference to the accompanying drawings. In general, according to one embodiment of the invention, a magnetic disk apparatus comprises a magnetic disk configured to store encrypted data; a magnetic head configured to read data from and to write data to the magnetic disk; and a recording and reproducing circuit connected to the magnetic head, wherein the recording and reproducing circuit configured to read data from an area of the magnetic disk, to decrypt read data, to re-encrypt decrypted data with changing a cipher key, and to rewrite re-encrypted data in the area of the magnetic disk.

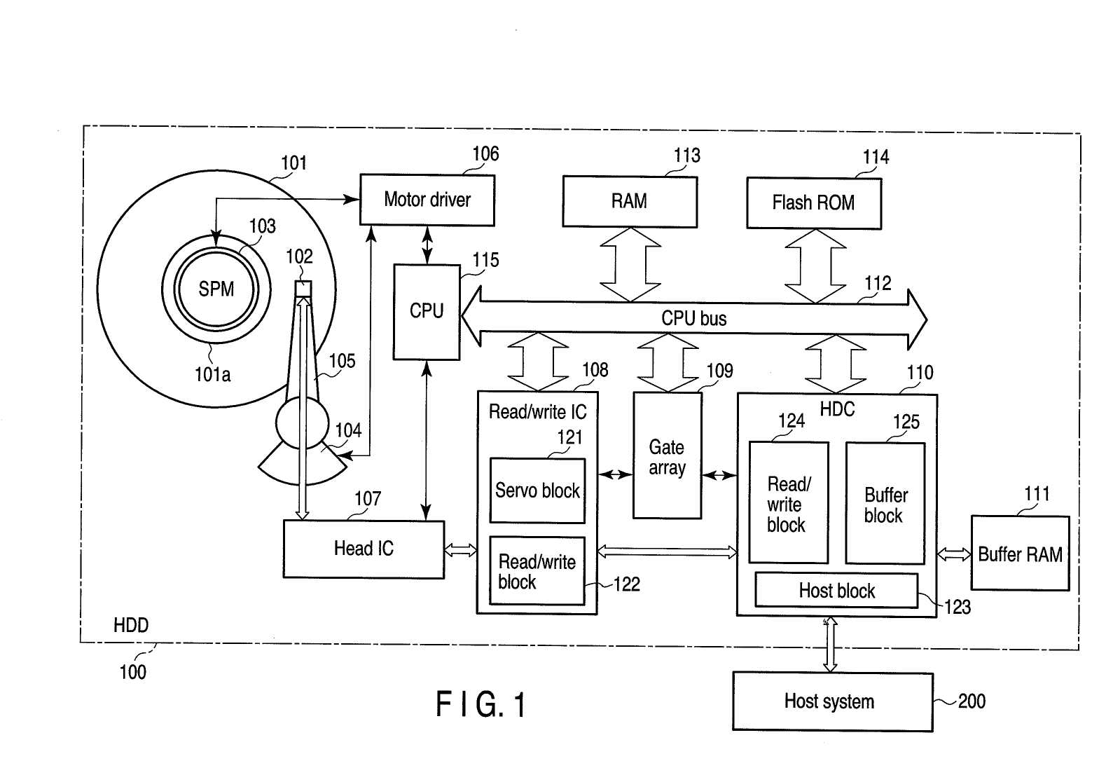

FIG. 1 is a block diagram showing a configuration of a hard disk drive (HDD) as an embodiment of a magnetic disk apparatus according to the invention. An HDD 100 shown in FIG. 1 writes or reads data (including encrypted data) to/from a recording surface of a disk (magnetic disk) 101, according to a request from a host system 200. The host system 200 is an electronic apparatus, such as a personal computer using the HDD 100 as a storage device.

The disk 101 is fixed to a spindle motor (SPM) 103, and is rotated at a constant speed when the SPM 103 is driven. One side of the disk 101 is formed as a recording surface for magnetic data recording. A head (magnetic head) 102 is provided facing the recording surface of the disk 101. The head 102 is fixed at one end of an actuator 105. The other end of the actuator 105 is fixed to a voice coil motor (VCM) 104. When the VCM 104 is driven, the head 102 moves in an area overlapping the surface of the disk 101 in a circular arc about the axis of the VCM 104.

In the configuration of FIG. 1, a HDD 100 having a single disk 101 is illustrated. However, two or more disks 101 may be fixed to the SPM 103 with certain spaces therebetween. In this case, two or more actuators 105 are fixed to the VCM 104, being fitted in the spaces between the disks 101. A head 102 is fixed to one end of each actuator 105. Therefore, when the SPM 103 is driven, all disks 101 are simultaneously rotated. When the VCM 104 is driven, all heads 102 are simultaneously moved. Further, in the configuration shown in FIG. 1, one side of the disk 101 forms a recording surface. However, a recording surface may be formed on both sides of the disk 101, and the head 102 may be provided facing each recording surface.

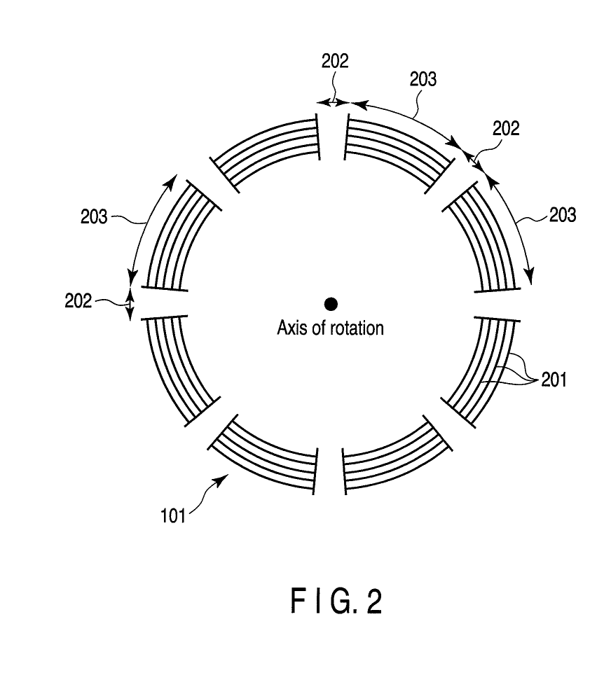

FIG. 2 is a conceptual diagram showing a format of the disk 101 including alignment of tracks.

In FIG. 2, two or more tracks 201 are arranged in a concentric pattern on the recording surface of the disk 101. Data from the host system 200 received by the HDD 100 is recorded in at least one of the tracks 201 according to the address specified by the host system 200.

Further, servo areas 202 and data areas 203 are alternately arranged with equal space in the tracks 201 on the disk 101. In the servo area 202, a servo signal used for positioning the head 102 is recorded. The data area 203 is used for recording the data transferred from the host system 200.

A recording format called constant density recording (CDR) is employed in the embodiment. The recording surface of the CDR format disk 101 is divided into two or more zones (CDR zones) in the radial direction of the disk 101. The number of data sectors per a track (cylinder) in each zone (hereinafter called a sector) is increased in the outer zones of the disk 101.

Referring again to FIG. 1, the CPU 115 functions as a main controller of the HDD 100. The CPU 115 starts, stops, and controls the SPM 103 to keep the rotation speed, through the motor driver 106. The CPU 115 drives and controls the VCM 104 through the motor driver 106, thereby moving the head 102 to a target track, and positioning within a target area in the track. The control of moving the head 102 to a target track is called a seek control, and the control of positioning the head 102 within a target area in the track is called a head positioning control. Further, the CPU 115 performs control for refreshing the data written to the tracks 201 of the disk 101 (a data refresh process).

A positioning of the head 102 is performed in the normal rotation state after the SPM 103 is actuated. As described above, the servo areas 202 are provided in the circumferential direction of the disk 101 with equal intervals. Therefore, servo signals recorded in the servo areas 202 appear with the same time intervals in the analog signal read from the disk 101 by the head 102 and amplified by a head IC 107. A read/write IC 108 (a servo block 121 included in the read/write IC 108) and gate array 109 generate a signal for positioning the head 102 by processing the above analog signal by using this state. The CPU 115 causes the motor driver 106 to supply the VCM 104 with a current (VCM current) for positioning the head 102 in real time by controlling the motor driver 106 based on the above signal.

As described above, while controlling the SPM 103 and VCM 104 through the motor driver 106, the CPU 115 controls other elements in the HDD 100, and processes commands. The CPU 115 is connected to a CPU bus 112.

The CPU bus 112 is connected to the read/write IC 108, gate array 109, disk controller (HDC) 110, RAM 113, and flash ROM 114. The flash ROM 114 is a rewritable nonvolatile memory. Here, data in the flash ROM 114 is rewritten under the control of the CPU 115.

The flash ROM 114 previously stores a program to be executed by the CPU 115. The above control of the CPU 115 is realized by the CPU 115 by executing the above program.

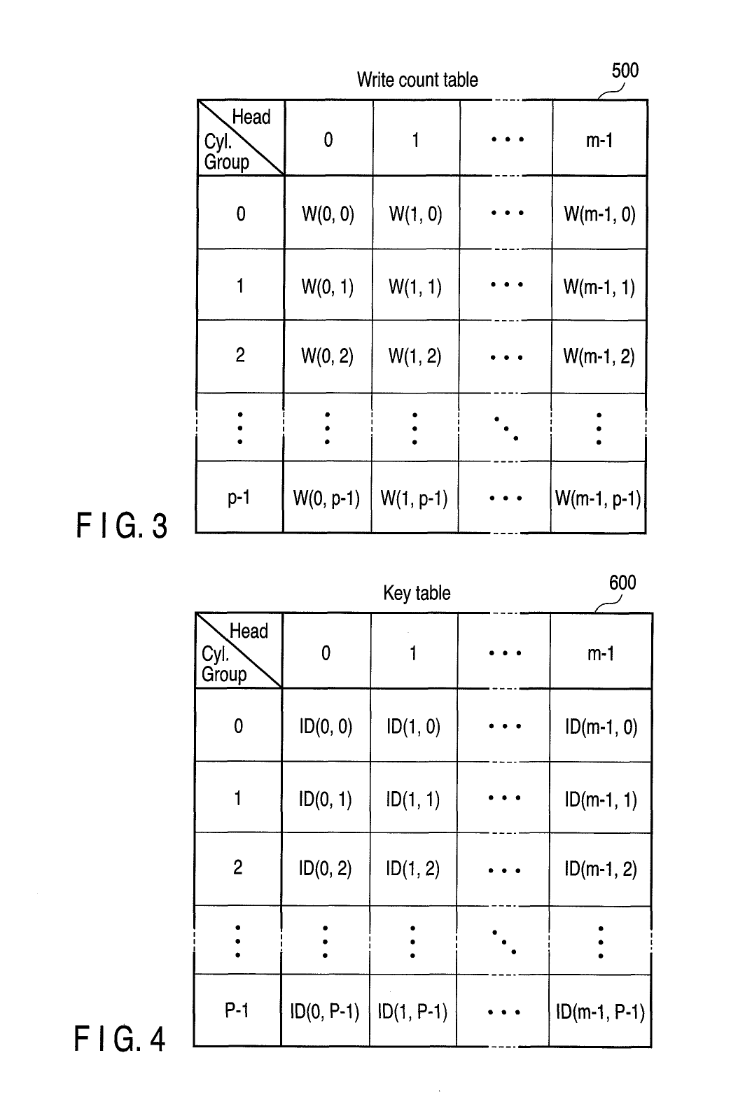

The RAM 113 is used to store various variables used by the CPU 115. A part of the storage area of the RAM 113 is used as a work area of the CPU 115. The other part of the RAM 113 is used for storing a write count table 500 (refer to FIG. 3), which stores the write number (the number of data writes, or the write execution number) for each track group.

The read/write IC 108 has a servo block 121, and a read/write block 122. The servo block 121 performs signal processing necessary for positioning the head 102, including extraction of a servo signal. The read/write block 122 performs signal processing (including encryption and decryption) for reading/writing data. The gate array 109 generates signals for control, including a signal for the extraction of a servo signal by the servo block 121.

The HDC 110 is connected to the read/write IC 108, gate array 109, and buffer RAM 111, in addition to the CPU bus 112. The HDC 110 has a host block 123, a read/write block 124, and a buffer block 125. The host block 123 has a host interface control function, which receives commands (write and read commands, etc.) transferred from the host system 200, and controls the data transfer between the host system and HDC 110. The read/write block 124 is connected to the read/write IC 108 and gate array 109, and reads (decrypts) and writes (encrypts) data through the read/write IC 108. The buffer block 125 controls the buffer RAM 111. A part of the storage area of the buffer RAM 111 is used as a write buffer for temporarily storing the data (write data) to be written to the disk 101 through the HDC 110 (the read/write block 124 in the HDC 110). The other part of the storage area of the buffer RAM 111 is used as a read buffer for temporarily storing the data (read data) read from the disk 101 through the HDC 110.

The read/write IC 108, gate array 109 and HDC 110 have a register for control. These registers for control are assigned to respective parts of the memory space of the CPU 115. By accessing these parts, the CPU 115 controls the read/write IC 108, gate array 109 and HDC 110 through the registers for control.

The recording surface of the disk 101 is provided with a security area 101a, which can be accessed from the CPU 115 that is a controller in the HDD 100, but cannot be accessed from the host system 200, and stores a key table storing identification data of cipher keys for each track group described later.

In the HDD 100 shown in FIG. 1, data is read as follows. At first, the head 102 reads a signal (analog signal) from the disk 101. The head IC 107 amplifies the read signal. The read/write IC 108 separates the amplified analog signal into a servo signal and a data signal. The data signal is decrypted by the read/write block 122 in the read/write IC 108, and sent to the HDC 110. The read/write block 124 in the HDC 110 processes the decrypted data signal according to the signal for control from the gate array 109, and generates data to be transferred to the host system 200. This process includes detection and correction of data error based on the ECC data described later. The generated data is once stored in the buffer RAM 111 by the buffer block 125 in the HDC 110, and transferred to the host system 200 by the host block 123 in the HDC 110.

Data is written as follows to the HDD 100 shown in FIG. 1. Data transferred from the host system 200 to the HDC 110 is received by the host block 123 in the HDC 110, and once stored in the buffer RAM 111 by the buffer block 125 in the HDC 110. The data stored in the buffer RAM 111 is read out by the buffer block 125, and sent from the read/write block 124 to the read/write IC 108. The data sent to the read/write IC 108 is encoded by the read/write block 122 in the read/write IC 108, and then encrypted. The encrypted data is sent to the head 102 through the head IC 107, and written to the disk 101 by the head 102. The above data reading/writing is performed under the control of the CPU 115. All data written to the HDD 100 are not necessarily encrypted. Data with low security may be written only by encoding without decrypting.

Recently, the capacity of an HDD has been increased, and the HDD 100 has high recording density and track density. As the track density is increased, the interval between adjacent tracks (recording tracks) on a disk (i.e., a track pitch) is shortened. Each track has the same width as a head (a write element included in a head). But, the width of distribution of a magnetic field (a recording magnetic field) generated by the head when writing data does not match the width of the head, and a magnetic field is applied (leaks) to the surrounding area. This condition is called write fringing.

If a track pitch is shortened, when data is written to a track with a head positioned to the track, data (recorded data) written to an adjacent track may be degraded by an error in positioning the head to the track and the influence of write fringing. If the degradation of recorded data (recorded signal) is repeated, reading of the recorded data becomes very difficult. In other words, it is difficult to recover the recorded data, even if recovery of the recorded data is attempted by fully using an error correction code (ECC).

Therefore, data refresh (rewriting) is necessary to restore the degradation of the recorded data before reading of the recorded data becomes impossible. Data refresh is known as an operation of restoring degraded recorded data to a normal state by reading degraded recorded data from a track and rewriting the read data in the original storage area of the track.

Next, data refresh executed by the HDD 100 in FIG. 1 will be explained. In this embodiment, the tracks 201 provided on the recording surface of the disk 101 are grouped in units of certain number of previously defined tracks, and data is refreshed for each group. This group is called a track group. Here, the total number (write number) of data writes to a whole track group is counted for each track group. When the counted value reaches a predetermined value, the data of the corresponding track group is refreshed.

FIG. 3 shows an example of a data structure of the write count table 500 storing the write number (the number of data writes, or the write execution number) for each track group. The write count table 500 is stored in a predetermined area of the RAM 113 in FIG. 1, for example.

In the example of the write count table 500 in FIG. 3, it is assumed for generalization of explanation that the HDD 100 has m number of heads 102, and comprises p number of cylinder groups. In this case, the write count table 500 stores the number of data writes (write count) to a track group W (h, c) (0≦h≦m−1, 0≦c≦p−1), for all track groups expressed by using a head (head number) h and cylinder group (cylinder group number) c. The write count W (h, c) is used as a write counter to count the number of data writes in a track group specified by the head number h and cylinder group number c. In the configuration of the HDD 100 in FIG. 1, m is 1.

A cylinder group is a certain predetermined number of cylinders, and the number of cylinders per a cylinder group is the same as the number of tracks per a track group. Therefore, a track group having the same cylinder group number exists as many as the number m of heads 102 in the HDD 100. A track group is specified by the cylinder group number c and head number h. When data is written (write access) in a track of a track group specified by the cylinder group number c and head number h, the write count (write counter) W (h, c) stored in the count table 500 is incremented by the write number.

In this embodiment, the write count table 500 is stored in the RAM 113 as described above. The contents of the RAM 113 are lost when the HDD 100 is turned off. The contents of the write count table 500 are also lost when the HDD 100 is turned off. Therefore, in this embodiment, the contents of a predetermined area in the RAM 113 including the write count table 500 are saved in a predetermined area of the disk 101, for example, in the security area 101a as needed (when the HDD 100 goes into a power-saving mode, for example). The contents including the write count table 500 saved in a predetermined area of the disk 101 are read and restored in the RAM 113 when the HDD 100 is activated (turned on).

FIG. 4 shows an example of a data structure of a key table 600 storing identification data of cipher keys for each track group. The key table 600 is stored in the security area 101a on the recording surface of the disk 101, for example, together with a cipher key corresponding to identification data ID (h, c). For example, key data is prepared for predetermined number of keys, and assigned at random to each track group in the initial state. When a cipher key is changed, the identification data ID (h, c) is changed. A key may be changed by selecting a random key, or may be cyclically changed by sequentially increasing or decreasing the identification data. All data is not necessarily encrypted as described above, and the identification data ID (h, c) is not stored for a track group unnecessary to encrypt. Security of a key is further increased by separately storing a key and identification data.

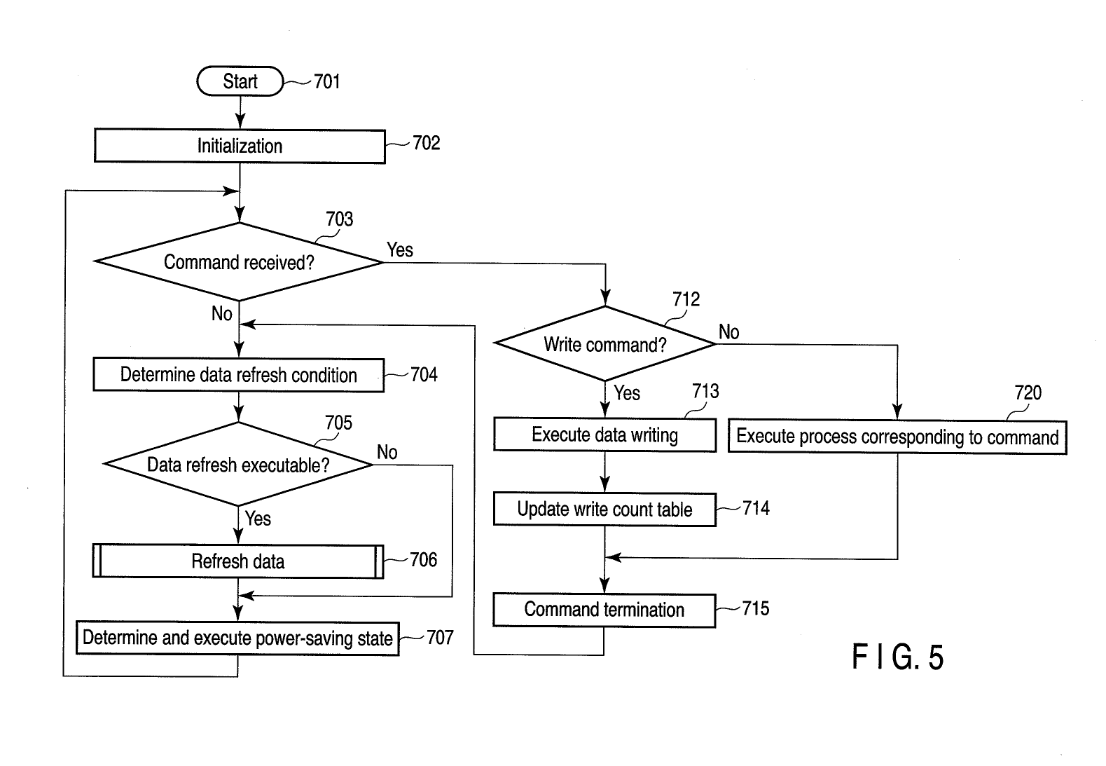

Next, the general operation in the HDD 100 will be explained by referring to the flowchart of FIG. 5.

First, the HDD 100 is turned on, and the CPU 115 is started (block 701). The CPU 115 initializes and activates the whole HDD 100 (block 702). Then, the CPU 115 goes into the state capable of receiving a command from the host system 200 through the HDC 110, and enters a command queue loop (block 703 to 707).

The CPU 115 confirms reception of a command from the host system 200 in block 703, and goes to block 712. The CPU 115 quits the command queue loop, and executes a process corresponding to the command from the host system 200. In block 712, the CPU 115 determines whether the command from the host system 200 is a write command. If it is a write command (Yes in block 712), the CPU 115 performs writing specified by the write command (block 713). If the write command specifies encryption of data, the data is encrypted by the read/write block 122.

After the write operation (block 713), the CPU 115 updates the write count table 500 so that the data write is reflected in the table 500 (block 714). In other words, when the write operation is performed for a track group identified by the head h and cylinder group c, the CPU 115 updates the write count table 500 so that the write count W (h, c) reflects the write operation. Specifically, the CPU 115 adds the number of data writes to the write count W (h, c) in the write count table 500. Usually, one is added. However, if a retry is executed in the write process, the retry influences an adjacent track as in ordinary writing, and the number of retries is also increased.

After execution of block 714, the operation of a write command is completed. The CPU 115 performs a command termination process, such as updating registers and resetting busy states (block 715), and returns to the command queue loop.

If the received command is not a write command (NO in block 712), the CPU 115 performs the process corresponding to the received command (block 720) and the command termination process (block 715), and returns to the command queue loop.

Next, a command is not received in block 703 in the command queue loop. In this case, idle run occurs. After the command termination process is executed in block 715, idle run occurs. Idle run includes data refresh. In this embodiment, the CPU 115 determines whether to refresh data before the data refresh process is executed (blocks 704 and 705).

First, in block 704, the CPU 115 comprehensively determines whether a command from the host system 200 must be immediately executed without refreshing data, or whether a data refresh process must be avoided. When a command is received from the host system immediately after block 715, the command must be immediately executed. A data refresh process must be avoided when the HDD 100 is used under unfavorable conditions, for example, when external vibration above a certain level is applied to the HDD 100 or the ambient temperature of the HDD 100 goes out of the range in which correct functioning of the HDD 100 is guaranteed.

Next, in block 705, the CPU 115 comprehensively determines whether data refresh is executable, from the result of the comprehensive determination in block 704. Only when data refresh is determined to be executable, the CPU 115 executes data refresh (block 706). Block 706 will be described in detail later.

The CPU 115 executes block 707, when data refresh is terminated in block 706, or when data refresh is determined to be non-executable in block 705. In block 707, the CPU 115 determines whether to execute power saving in order to shift to a power-saving state, and executes power saving if necessary. A power-saving process includes unloading the head 102 from the disk 101, and/or stopping the SPM 103.

When the power-saving process is executed in block 707, the CPU 115 returns to block 703. In contrast, when it is necessary to immediately execute a command from the host system 200, the power-saving process is determined to be unnecessary to execute. In this case, the CPU 115 returns to block 703 without executing the power-saving process. Thereafter, the CPU 115 repeats the above processes including block 703.

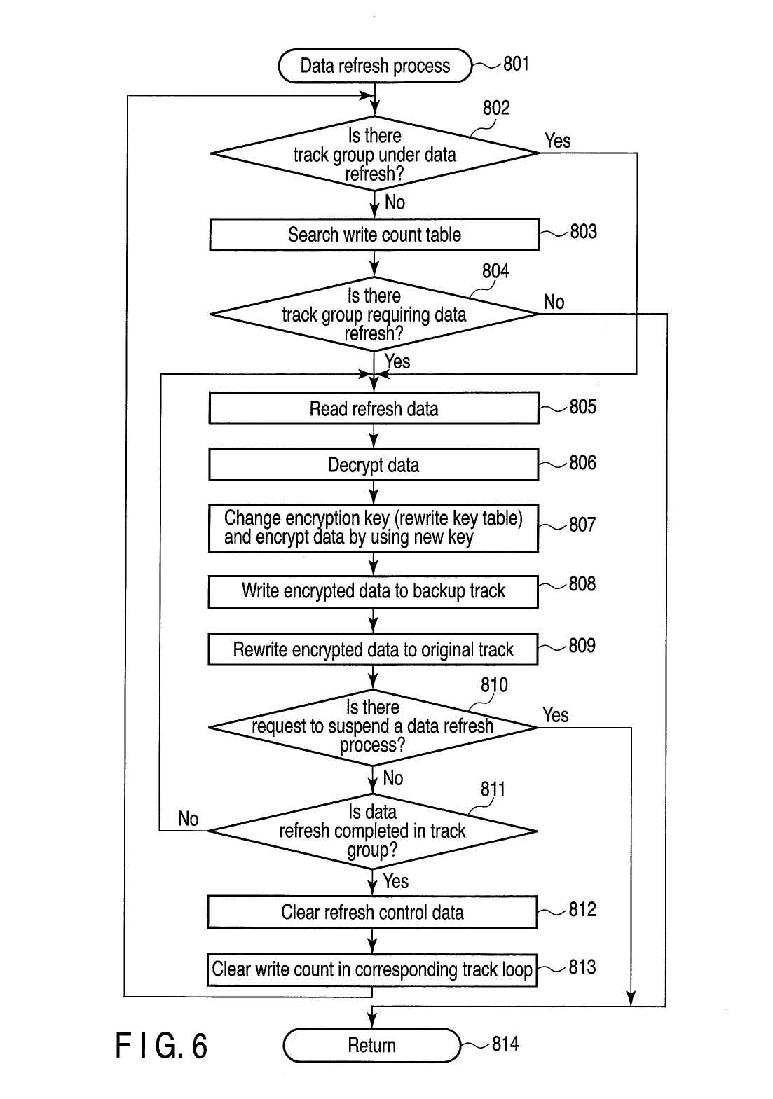

Next, detailed blocks of the data refresh process in above block 706 will be explained by referring to the flowchart of FIG. 6.

In a data refresh process 801 shown in the flowchart of FIG. 6, the CPU 115 first determines whether there is a track group in which a data refresh process is suspended (block 802). Block 802 concerns suspension of a data refresh process for each block in a track group.

A long time is required to refresh data in all tracks in a track group, and response to a command from the host system 200 received during a data refresh process is lowered. Therefore, a data refresh process can be suspended for each block in a track group to prevent lowering of response. In other words, in this embodiment, when a command from the host system 200 is received during execution of a data refresh process, the data refresh process is suspended until the received command is executed.

When there is a track group in which a data refresh process is suspended (YES in block 802), it means that a track group to be refreshed (hereinafter, called a refresh track group) is determined. In this case, the CPU 115 first reads the data (refresh data) in a refresh track group, to execute data refresh (block 805). If the read data is encrypted (the identification data of a cipher key is stored in an area in a corresponding track group on the key table 600), the CPU 115 decrypts the cipher key data corresponding to the identification data in block 806, and restores the original data. In block 807, the CPU 115 changes the cipher key of the corresponding track group (rewrites the ID (I, j) in the key table 600), and encrypts the original data by using a new key. In block 808, the CPU 115 writes the encrypted data in a predetermined spare area (called a backup track). A backup track is provided in outer tracks or the outer-most track of the disk 101, for example. In block 809, the CPU 115 rewrites the data to the original track group. Thereby, the cipher key is changed at every data refresh, and the security of encrypted data is improved. Further, as the data to be rewritten is stored in a backup track, even if power is interrupted while data is rewritten in an original track group, the data can be read from a backup track and can be rewritten. This prevents data from being lost during data refresh.

If the read data is not encrypted, blocks 806 and 807 are not executed, the read data is written to a backup track in block 808, and the read data is rewritten to the original track group in block 809.

If there is no refresh track group in which a data refresh process is suspended (NO in block 802), the CPU 115 searches for a new refresh track group in the write count table 500 (block 803). Here, the CPU 115 searches for a largest write count W (h, c) in the write count table 500. Depending on whether the searched W (h, c) is larger than a certain predetermined value, the CPU 115 determines whether a track group requiring data refresh is present (block 804).

When the searched write count W (h, c) is larger than a predetermined value, the CPU 115 determines that a track group requiring data refresh is present, and this track group is the track group corresponding to the write count W (h, c) (a track group expressed by a head number h and a cylinder group number c) (YES in block 804). When the presence of a track group requiring data refresh (a refresh track group requiring data refresh) is determined, the track group corresponding to the largest write count W (h, c) is also identified. Thereafter, blocks subsequent to reading refresh data in block 805 will be executed.

In contrast, if the searched write count W (h, c) is lower than a predetermined value, the CPU 115 determines a track group requiring data refresh is not present (NO in block 804). In this case, it is unnecessary to control data refresh, and the CPU 115 returns from the data refresh process in block 801 to the original process (block 814). Thereby, block 707 in the flowchart of FIG. 5 is executed.

After the data refresh process (block 809), the CPU 115 determines whether a request to suspend a data refresh process is present (block 810). One of the conditions to determine the presence of a request to suspend a data refresh process is to receive a command from the host system 200. When the host block 123 in the HDC 110 receives a command from the host system 200, the HDD 100 is immediately set to a busy state by the hardware function of the host block 123. At the same time, a flag indicating a busy state (a busy flag) is set. The CPU 115 checks the state of a busy flag in block 810.

A busy flag is set regardless of whether data is being refreshed. Therefore, the response time of a command recognized by the host system 200 is the total of the execution time of an original command and the time required by the data refresh process under execution after the command is issued. Therefore, when a command from the host system 200 is received, if the operation is suspended until all data in a refresh track group are refreshed, the response to the command is lowered.

To avoid lowering of the response to a command, in this embodiment, whenever data refresh in a refresh block is completed, whether a request to suspend a data refresh process is present is determined as described above (block 810). Just like when a command from the host system 200 is received during execution of a data refresh process, if a request to suspend a data refresh process is present (YES in block 810), the CPU 115 returns to the original process (block 814). In other words, to start a process for the command from the host system 200, the CPU 115 immediately suspends a data refresh process, and finishes block 706 (refer to FIG. 5).

After block 706, the CPU 115 executes block 707. In block 707, also, as the CPU 115 immediately branches to block 703, and starts a process for the command from the host system 200, a process similar to block 810 is executed.

In contrast to the above, if a request to suspend a data refresh process is not present (NO in block 810), the CPU 115 determines whether all data in a refresh track group have been refreshed (block 811). If all data in a refresh track group have not refreshed (NO in block 811), the CPU 115 returns to block 805, and continues controlling the data refresh process. If all data in a refresh track group have been refreshed (YES in block 811), the CPU 115 branches to block 812, and quits a process loop (a track group process loop) of blocks 805 to 811.

In block 812, the CPU 115 clears the refresh control data to indicate that all data in a refresh track group have been refreshed and no track group is under processing. By clearing the refresh control data, the CPU 115 can correctly determine in block 802, after returning from block 813 to block 802.

After executing block 812, the CPU 115 initializes (clears) the write count W (h, c) stored in the write count table 500 by corresponding the refresh track group in which all data have been refreshed (block 813).

The write count W (h, c) for each track group stored in the write count table 500 indicates the number of data writes to the track group. The write count W (h, c) correlates with the degree of degradation of data in the track group corresponding to the write count W (h, c). Therefore, in this embodiment, the write count W (h, c) is handled as a value indicating the degradation degree of data.

Immediately after the data in a refresh track group is refreshed, the data in the refresh track group is not degraded. The corresponding write count W (h, c) is initialized to zero as described above (block 813) in order to reflect this fact in the write count W (h, c) corresponding to the refresh track group in which a data refresh process is completed.

After executing block 813, the CPU 115 branches again to block 802, and starts a process for the next track group. In this case, block 802 is always branched to block 803, and a process including an operation of searching for a track group requiring data refresh is executed as described above. If a request to suspend a data refresh process is not present, a data refresh process in a refresh track group is finished only when no track groups require data refresh (NO in block 804).

As described herein, according to this embodiment, when data is refreshed in a hard disk unit, read refresh data is decrypted, and data encrypted by using another cipher key is rewritten, thereby a cipher key is automatically and securely updated, and the security of the encrypted data is improved. Further, as a data refresh process includes reading and writing data, it is unnecessary to read or write data only for updating a cipher key. Decryption of encrypted data and re-encryption of original data are simply added to an ordinary data refresh process, and it is unnecessary to read or write data twice for refreshing data or updating a key. Therefore, a cipher key can be updated in a short time with little processing overhead without increasing the load on the hard disk unit.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

For example, in this embodiment, a cipher key is changed when data is refreshed. Changing of a cipher key is not limited to this timing. A cipher key may be changed at other timings. For example, when the interval in the data refresh process 706 is measured and a certain time elapses after the last data refresh, a cipher key may be forcibly changed regardless of whether the data refresh process 706 is performed; in other words, blocks 805 to 809 in FIG. 6 may be performed. According to the invention, a cipher key is changed at least simultaneously with refreshing of data.

Generally, a hard disk unit called a self-monitoring, analysis and reporting technology (SMART) has a function of self-monitoring, analysis and reporting. The SMART function includes a self-test function to perform various kinds of functional test of a hard disk unit itself, and a whole disk is scanned at the time of self-test. All data of a disk is read when a whole disk is scanned. Therefore, a cipher key can be changed by decrypting, re-encrypting and rewriting the read data. In other words, blocks 805 to 809 in FIG. 6 may be performed at the time of self-test. Further, as described in a disk-fixed hard disk unit, the invention is applicable to a magnetic disk apparatus, in which a magnetic disk and a controller are separated.

What is claimed is:

1. A magnetic disk apparatus comprising:
a magnetic disk configured to store encrypted data;
a magnetic head configured to read encrypted data from the magnetic disk and to write encrypted data to the magnetic disk; and
a recording and reproducing module connected to the magnetic head,
wherein the recording and reproducing module is configured to read encrypted data from an area of the magnetic disk, to decrypt the read data, to re-encrypt decrypted data with a cipher key updated from previous encryption, and to rewrite re-encrypted data in the area of the magnetic disk.

2. The apparatus of claim 1, wherein the recording/reproducing module comprises:
a determination module configured to count a number of data writing for an area of the magnetic disk, and to determine whether the number of data writing for the area is larger than a predetermined number; and
an update module configured to read encrypted data from the area, to decrypt the read data, to re-encrypt the decrypted data with the updated cipher key, and to rewrite re-encrypted data in the area when the determination module determines that the number of data writing is larger than the predetermined number.

3. The apparatus of claim 2, wherein the update module comprises a key storage module configured to store a predetermined number of cipher keys, and a table configured to store information indicative of cipher keys for areas, and to update information in the table after reading and decrypting encrypted data.

4. The apparatus of claim 3, wherein the key storage module and the table are in a security area of the magnetic disk.

5. The apparatus of claim 2, wherein the update module is configured to rewrite encrypted data in the area after writing re-encrypted data with the updated key in a backup area different from the area.

6. The apparatus of claim 2, wherein the area comprises tracks, and a backup area comprises a predetermined number of tracks.

7. The apparatus of claim 2, further comprising:
a test module configured to perform a self test of the magnetic disk; and
a second update module configured to decrypt encrypted data read during the self test, to re-encrypt decrypted data with a cipher key updated from previous encryption, and to rewrite re-encrypted data.

8. A recording and reproducing apparatus configured to read encrypted data from and write encrypted data into a magnetic disk, the apparatus comprising:
a data refresh module configured to read data from an area of the magnetic disk, to decrypt the read data, to re-encrypt decrypted data with a cipher key updated from previous encryption, and to rewrite re-encrypted data in the area of the magnetic disk.

9. The apparatus of claim 8, further comprising:
a determination module configured to count a number of data writing for an area of the magnetic disk, and to determine whether the number of data writing is larger than a predetermined number; and
an update module configured to read encrypted data from an area, to decrypt the encrypted data, to re-encrypt the decrypted data with the updated cipher key, and to rewrite re-encrypted data in the given area when the determination module determines that the number of data writing is larger than the predetermined number.

10. The apparatus of claim 9, wherein the update module comprises a key memory configured to store a predetermined number of cipher keys, and a table configured to store information indicative of cipher keys for areas, and to update information in the table after reading and decrypting encrypted data.

11. The apparatus of claim 9, wherein the update module is configured to rewrite encrypted data in the area after writing re-encrypted data with the updated key in a backup area different from the given area.

12. The apparatus of claim 8, further comprising:
a test module which performs a self test of the magnetic disk; and
a second update module configured to decrypt encrypted data read during the self test, to re-encrypt decrypted data with a cipher key updated from previous encryption, and to rewrite re-encrypted data in a same area.

13. A method of updating a cipher key of encrypted data stored on a magnetic disk, comprising:
counting a number of data writing for an area of the magnetic disk to determine whether the number of data writing is larger than a predetermined number; and
reading encrypted data from an area of the magnetic disk, decrypting the read data, re-encrypting the decrypted data with the updated cipher key, and rewriting re-encrypted data in the area of the magnetic disk when it is determined that the number of data writing is larger than a predetermined number.

14. The method of claim 13, wherein the re-encrypted data is rewritten in the area after the re-encrypted data is written in a backup area different from the area.

15. The method of claim 13, further comprising:
performing a self test of the magnetic disk; and
decrypting encrypted data read during the self test, re-encrypting decrypted data with a cipher key updated from previous encryption, and rewriting re-encrypted data.
